(19) United States
(12) Patent Application Publication
(10) Pub. No.: US 2014/0136274 A1
(43) Pub. Date: May 15, 2014

(54) PROVIDING MULTIPLE LEVEL PROCESS INTELLIGENCE AND THE ABILITY TO TRANSITION BETWEEN LEVELS

(71) Applicants: Oliver Kieselbach, Bielefeld (DE); Christoph Liebig, Heddesheim (DE); Thomas Volmering, Walldorf (DE)

(72) Inventors: Oliver Kieselbach, Bielefeld (DE); Christoph Liebig, Heddesheim (DE); Thomas Volmering, Walldorf (DE)

(73) Assignee: SAP AG

(21) Appl. No.: 13/674,770

(22) Filed: Nov. 12, 2012

(51) Int. Cl. G06Q 10/06

(52) U.S. Cl. CPC G06Q 10/0633
USPC 705/7.27

(57) ABSTRACT

The present disclosure involves systems, software, and computer implemented methods for providing process intelligence by allowing analysis of running business processes at multiple levels of detail. One computer-implemented method includes identifying a first data layer, a second data layer, and a third data layer associated with a business process management system, the third data layer derived from the second data layer and including at least one reference to the second data layer and the second data layer derived from the first data layer and including at least one reference to the first data layer, presenting at least a portion of one of the first data layer, the second data layer, or the third data layer as a first presented data layer, identifying a request to present a data layer different than the first presented data layer, the request identifying at least a portion of the data included in the first presented data layer, and presenting at least a portion of the requested data layer associated with the identified data included in the first presented data layer as a second presented data layer.

### TECHNICAL FIELD

The present disclosure relates to computer-implemented methods, software, and systems for providing process intelligence by allowing analysis of running business processes at multiple levels of detail.

### BACKGROUND

Process intelligence solutions generally allow analysts a particular view into data generated by running business processes. Business process analysts may use this information to optimize a particular business process. Different types of analyses may require different granularities of information, or may require viewing the data in different ways. This may necessitate time consuming data mining by the analyst. Further, for business scenarios including multiple process instances running in multiple business systems, a business process analyst may be required to access different systems in order to obtain an accurate view of a running business process that spans multiple business process systems.

### SUMMARY

The present disclosure involves systems, software, and computer-implemented methods for providing process intelligence by allowing analysis of running business processes at multiple levels of detail. One example computer-implemented method includes identifying a first data layer, a second data layer, and a third data layer associated with a business process management system, the third data layer derived from the second data layer and including at least one reference to the second data layer and the second data layer derived from the first data layer and including at least one reference to the first data layer, presenting at least a portion of one of the first data layer, the second data layer, or the third data layer as a first presented data layer, identifying a request to present a data layer different than the first presented data layer, the request identifying at least a portion of the data included in the first presented data layer, and presenting at least a portion of the requested data layer associated with the identified data included in the first presented data layer as a second presented data layer.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for storing a multi-layer data set based on events generated by running business processes and allowing seamless transition between the different layers in the data set.

FIG. 2 is a block diagram illustrating an example system for processing events received from event sources to produce the multi-layered data set.

FIG. 3 is a flowchart of an example method for allowing seamless transition between different layers in a business process event data set.

FIG. 4 illustrates an example data format for an example first data layer of an example multi-layer data set.

FIG. 5 illustrates an example data format for an example second data layer of the example multi-layer data set.

FIG. 6 illustrates an example data format for an example third data layer of the example multi-layer data set.

FIG. 7 is a flowchart of an example method for processing business process event data received from various event sources.

FIG. 8 is a flowchart of an example method for transitioning from a high level view of business process data to a lower level view.

### DETAILED DESCRIPTION

The present disclosure relates to computer-implemented methods, software, and systems for providing process intelligence by allowing analysis of running business processes at multiple levels of detail.

Users of process intelligence solutions generally view data related to one of three observation use cases: operational observation, tactical observation, and strategic observation. In the operational observation use case, a single user requires data from individual processes to gain insight into individual participation in the process. In the tactical observation use case, a process intelligence solution offers process owners intelligent assistance to analyze and control process performance at a fine-granular level (e.g., at the level of single instances). In the strategic observation use case, the process intelligence solution supports management of an overall process flow through easy to understand Key Performance Indicators (KPI) and their appropriate visualization (e.g., on dashboards), as well as other analytical presentations of the underlying data. Each of these observation use cases requires the same source information presented in different ways. The granularity of information presented decreases when moving from operational to strategic observation.

With recent advances in database technology such as in-memory computing and columnar data stores, increasingly large data sets can be stored and accessed more quickly. This ability to handle massive data sets allows increasingly complex calculations to be performed and the results stored with less concern for storage and performance issues. Further, these database advances allow increasingly complex transient views of stored data to be defined and presented.

One goal of the present disclosure is to provide process intelligence by allowing analysis of running business processes at multiple levels of detail, and by allowing seamless transitions between the multiple levels of detail. In some instances, this is accomplished by examining event data produced by running business processes, also referred to as “flow events.” A flow event indicates a transition in the life cycle within a running flow (e.g., a workflow, a process orchestration, a sequence of user interactions, a sequence of sensor events triggering actions, or another type of business process). In some instances, the present solution collapses the required technology layer for processing and analyzing the provisioned flow event information for any kind of observation style. This may be achieved by leveraging one or more of database technology innovations described above, which are able to store and handle large amounts of data and make extensive use of parallel execution concepts to ensure high throughput for database queries of different kinds.

In some cases, the present solution may employ a layering organization scheme with respect to business process information, so the information used for different observation styles can be derived at any time from the provisioned flow event data. As part of this layering organization scheme, the data may be divided into several layers. In some instances, the layers may include a layer containing “raw” flow event data representing at least a portion of the original event information about life cycle changes in the observed flows. Depending on the capabilities of the underlying flow runtime (e.g., a BPM engine) various kinds of flow events are raised. The information provided by this layer may be used to drill into any flow or process instance. In some instances, the layers may also include a layer of business scenario data representing information required to provide tactical observations. A “business scenario” is a collection of one or more business process instances that execute and/or interact with each other. The business scenario data may combine raw flow event information from concrete flow instances while filtering out only those sets of event data necessary to allow the process owner to gain insight and derive tactical decisions. In other instances, the layers may also include a layer of analytical process views representing the most coarse grained information layer. This layer aggregates information (e.g., based on historical information), and uses prediction capabilities to calculate trends and forecasts, as well as to analyze prior information, including performance related to KPIs, among others.

In some cases, the data layers may include both persistent and transient data layers. Persistent data layers are data stored in some form in a database or other data store. Transient data layers are computed in response to a request for the data. In some cases, transient data layers may be derived from or enriched by other data layers. For example, the analytical data layer described above may be generated in response to a request by processing data included in the observational data layer. Further, persistent data layers may be derived from or enriched by data from other persistent and/or transient data layers.

In some instances, the different data layers may reside in a single infrastructure, which may allow references between the different data layers. These references may allow a seamless transition between the different process intelligence views from strategic to tactical, down to operational, without requiring different infrastructures.

Users of the present solution may include both process workers, process participants, and other business users who desire transparency into running business processes at the time a decision related to the process needs to be made (i.e. business real-time). The present solution may enable such users to make pro-active decision to ensure a desired business outcome or at least to mitigate issues that may arise. Users of the present solution may include: the requester of a particular “case” (e.g., a customer purchaser filing an order), process participants who have a particular responsibility in the process (e.g., a sales person negotiating a discount, a financial accountant recognizing the negotiated discount in order filing, etc.), or any other appropriate users.

The present solution may also allow decisions related to running business processes to be made online (i.e. while the processes are running). Events and data for the various levels described are pushed into the system as the activities of the processes and the real-world events are happening. So the present solution is able to handle and provide history data, current data, and predictions for future conditions of the business process based on the history and current data.

Another aspect of the present solution is that the views produced by the solution may accommodate different user perspectives. For example, one user of the present solution may only see 2 phases within a business process, while another user may see the entire process end-to-end. In some cases, different user-specified views can provide visibility into the same level of data, but can filter or process the data in different ways so that the individual users receive views customized to their individual analysis needs.

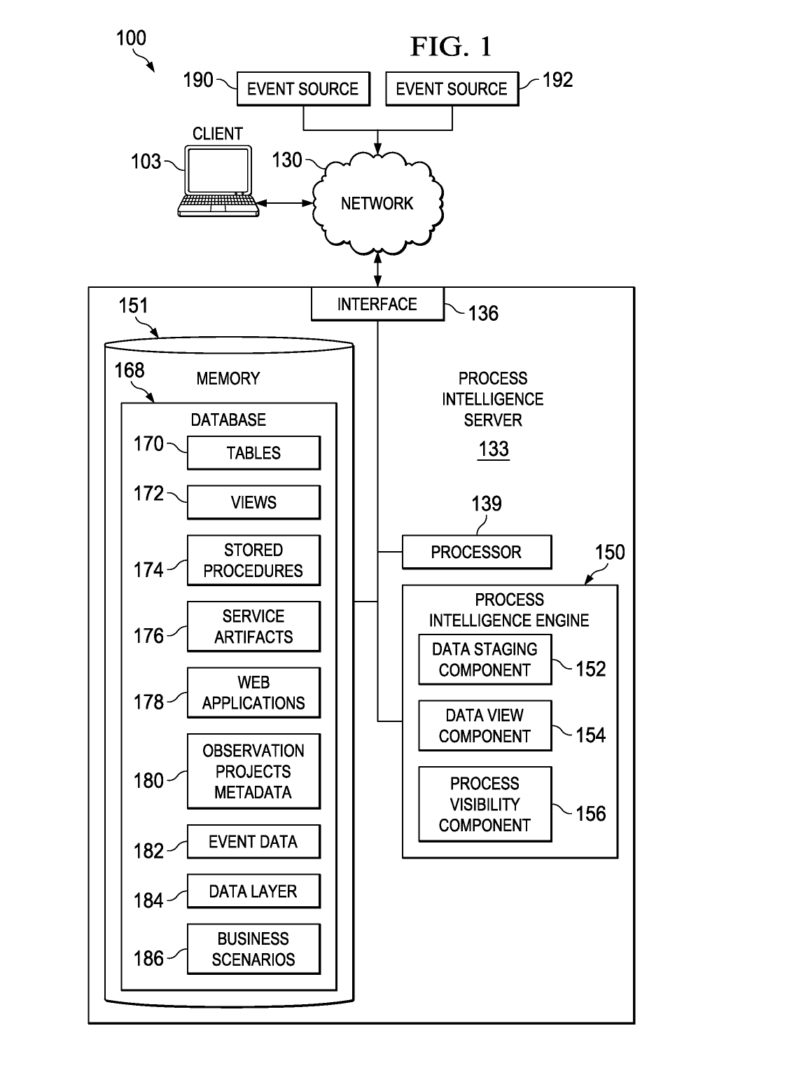

FIG. 1 is a block diagram illustrating an example system 100 for providing process intelligence by allowing analysis of running business processes at multiple levels of detail. Specifically, the illustrated environment 100 includes or is communicably coupled with one or more clients 103, one or more event sources 190 and 192, and a network 130.

The example system 100 may include a process intelligence server 133. At a high level, the process intelligence server 133 comprises an electronic computing device operable to receive, transmit, process, store, or manage data and information associated with the environment 100. Specifically, the process intelligence server 133 illustrated in FIG. 1 is responsible for receiving, retrieving, or otherwise identifying events from various event sources, such as event sources 190 and 192, and processing those events to produce one or more views, allowing an analyst to investigate various properties and performance of one or more running business applications. In some cases, the process intelligence server 133 may receive requests from one or more clients 103. These requests may include requests for data from various layers, requests for transient data layers or views, and configuration requests related to the processing and generation of the various data layers.

As used in the present disclosure, the term “computer” is intended to encompass any suitable processing device. For example, although FIG. 1 illustrates a process intelligence server 133, environment 100 can be implemented using two or more servers, as well as computers other than servers, including a server pool. Indeed, process intelligence server 133 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, illustrated process intelligence server 133 may be adapted to execute any operating system, including Linux, UNIX, Windows, Mac OS®, Java™, Android™, iOS or any other suitable operating system. According to one implementation, process intelligence server 133 may also include or be communicably coupled with an e-mail server, a Web server, a caching server, a streaming data server, and/or other suitable server.

The process intelligence server 133 also includes an interface 136, a processor 139, and a memory 151. The interface 136 is used by the process intelligence server 133 for communicating with other systems in a distributed environment—including within the environment 100—connected to the network 130; for example, the client 103, as well as other systems communicably coupled to the network 130 (not illustrated). Generally, the interface 136 comprises logic encoded in software and/or hardware in a suitable combination and operable to communicate with the network 130. More specifically, the interface 136 may comprise software supporting one or more communication protocols associated with communications such that the network 130 or interface's hardware is operable to communicate physical signals within and outside of the illustrated environment 100.

As illustrated in FIG. 1, the process intelligence server 133 includes a processor 139. Although illustrated as a single processor 139 in FIG. 1, two or more processors may be used according to particular needs, desires, or particular implementations of the environment 100. Each processor 139 may be a central processing unit (CPU), a blade, an application specific integrated circuit (ASIC), a field-programmable gate array (FPGA), or another suitable component. Generally, the processor 139 executes instructions and manipulates data to perform the operations of the process intelligence server 133. Specifically, the processor 139 may execute the functionality required to receive and respond to requests from the client 103, as well as to receive flow events from the event sources 190 and 192 and process these flow events to produce the various data layers required for the various views configured in the process intelligence server 133.

The illustrated process intelligence server 133 also includes a process intelligence engine 150. In some cases, the process intelligence engine 150 may produce and organize data for use in the process intelligence server 133. This may include receiving business process events from the event sources 190 and 192, storing those events in a data store (such as database 168), and processing the events to produce various layers corresponding to views of the running business processes. In some instances, the process intelligence engine 150 is implemented as a software application executing on the process intelligence server 133. In other instances, the process intelligence engine 150 is implemented as a collection of software applications executing on one or more process intelligence servers as part of a distributed system. In still other instances, the process intelligence engine 150 is implemented as a separate hardware and/or software component separate from the process intelligence server 133. The process intelligence engine 150 may include one or more different components, such as those described below. These components may be separate software libraries, separate software applications, separate threads, or separate dedicated hardware appliances. In some implementations, certain components may be omitted or combined or additional components may be added.

In the depicted implementation, the process intelligence engine 150 includes a data staging component 152, a data view component 154, and a process visibility component 156. In some instances, the data staging component 152 may be operable to receive business process events from the event sources 190 and 192 and perform processing on the events to interpolate, extract, and/or derive additional information from them based on the events themselves and/or configuration information relating to the event sources and the running business processes.

In some implementations, the data staging component 152 may be operable to transform events from a particular event source into a common format used by the process intelligence server 133. For example, events received from an event source in business process modeling notation (BPMN) format may be transformed into a normalized format before storage in database 168. Further, events received from an event source in a business process execution language (BPEL) format may be transformed into the same normalized format so that the remainder of process intelligence server 133 can operate on them. This harmonization or normalization of events in different formats from various event sources may allow a unified view of a business process running across different business process systems.

Data staging component 152 may also perform correlation of events from different systems or from different business process instances to produce a unified view of the activity of a business scenario. As discussed previously, a business scenario is a collection of one or more business process instances that execute and/or interact with each other. For example, a first process instance running on a first system may perform a task and then transfer control to a second process instance running on a second system. The data staging component 152 may correlate events generated by different processes and process instances in different systems to a single business scenario instance. By correlating the event data in this manner, the data staging component 152 may provide a view into the overall operation of a business process, rather than a view into only the portion of the process handled by a certain system. In some cases, this correlation step is driven by configuration data, such as observation projects metadata 180 (discussed below). Therefore, correlations between different process instances can be dynamically determined and updated by an analyst or by input from other systems.

In some cases, data staging component 152 may also perform more complex operations on the received event data. In some cases, the data staging component 152 may derive additional events beyond what is received from the event sources. For example, the data staging component 152 may derive from the receipt of a “stop” event for a certain process instance that a subsequent process instance responsible for the next task in a business scenario has started, and may thereby create a “start” event for that process instance. In another case, the data staging component 152 may filter out events from particular process instances that are not important. The data staging component 152 may determine which events are important by examining configuration data provided by an analyst or by an external system, such as, for example, the observer projects metadata 180. For example, an analyst may decide that informational status events produced by certain process instances do not contain any useful information about the given business scenario, and therefore may choose to configure the data staging component 152 to filter these events. In other cases, events may be filtered by many different criteria including, but not limited to, the source of the event, the type of the event, the process instance associated with the event, the task to which the event is associated, one or more actors associated with the event, or any other appropriate criteria.

In some implementations, the data staging component 152 may store the results of its operations in the database 168 or in some other data store. In other implementations, the data staging component 152 may perform its processing on-demand when a request for specific data is received. In other cases, the data staging component 152 stores the event data received from the event sources 190 and 192 in the database 168. In still other instances, another component is responsible for storing the received event data in the database 168 and the data staging component 152 accesses the event data for processing through the database 168.

Process intelligence engine 150 may also include a data view component 154. In some cases, the data view component 154 may produce various views into the stored data according to configuration information, such as the observation projects metadata 180, the views 172, or any other appropriate configuration data. The views produced by the data view component may be either transient (i.e., produced in response to a request) or persistent (i.e., pre-computed and stored). The data view component 154 may produce its view by operating on data output and/or stored by the data staging component 152, by operating directly on events received from the various event sources 190 and 192, or by a combination of methods.

The process intelligence engine 150 may further include a process visibility component 156 that provides an interface for configuration and control of the features of the process intelligence server 133. Specifically, the process visibility component 156 allows an analyst, an administrator, an external system, or other suitable user to configure the various views, data processing, data correlation, event derivation, and other features of the process intelligence server 133. In some implementations, this configuration is performed by creating, editing, updating, and/or deleting the observation projects metadata 180. The process visibility component 156 may include a web interface allowing a user to specify the observation projects metadata 180. The process visibility component 156 may also include an application programming interface (API) allowing external programs and systems to do the same. The process visibility component 156 may also be distributed on both the process intelligence server 133 and the one or more clients 103 as part of a client/server application.

The process visibility component 156 may further allow a user or external system to specify various business scenarios for analysis by the system. To this end, the process visibility component 156 may present a list of business process instances and allow selection and grouping of the instances into business scenarios representative of larger processes that span multiple instances and/or business process systems. By allowing the identification of these business scenarios, the process visibility component 156 allows the system to be configured to present complex views of the data that are not practical by manually examining data from one system in isolation.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The process intelligence server 133 also includes a memory 151, or multiple memories 151. The memory 151 may include any type of memory or database module and may take the form of volatile and/or non-volatile memory including, without limitation, magnetic media, optical media, random access memory (RAM), read-only memory (ROM), removable media, or any other suitable local or remote memory component. The memory 151 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the process intelligence server 133. Additionally, the memory 151 may include any other appropriate data, such as VPN applications, firmware logs and policies, firewall policies, a security or access log, print or other reporting files, as well as others.

As illustrated in FIG. 1, memory 151 includes or references data and information associated with and/or related to providing multiple process intelligence views related to running business applications. As illustrated, memory 151 includes a database 168. The database 168 may be one of or a combination of several commercially available database and non-database products. Acceptable products include, but are not limited to, SAP® HANA DB, SAP® MaxDB, Sybase® ASE, Oracle® databases, IBM® Informix® databases, DB2, MySQL, Microsoft SQL Server®, Ingres®, PostgreSQL, Teradata, Amazon SimpleDB, and Microsoft® Excel, as well as other suitable database and non-database products. Further, database 168 may be operable to process queries specified in any structured or other query language such as, for example, Structured Query Language (SQL).

Database 168 may include different data items related to providing different views of process intelligence data. The illustrated database 168 includes one or more tables 170, one or more views 172, one or more stored procedures 174, one or more service artifacts 176, one or more Web Applications 178, one or more observation projects metadata 180, a set of event data 182, and one or more data layers 184. In other implementations, the database 168 may contain any additional information necessary to support the particular implementation.

The tables 170 included in the illustrated database 168 may be database tables included as part of the schema of database 168. The tables 170 may also be temporary or transient tables created programmatically by requests from the clients 103 or from any other source. In some implementations, the structure of tables 170 may be specified by SQL statements indicating the format of the tables and the data types and constraints of the various columns. Further, the tables 170 may include any indexes necessary to allow for rapid access to individual rows of the tables. These indexes may be stored along with the tables 170, or may be stored separately in the database 168 or another system.

The views 172 included in the illustrated database 168 may be pre-computed or transient views into the data stored in the database 168. Generally, a view is query that is specified and stored in the database for quick retrieval. In some instances, the views will be specified in the same manner as standard database tables, with additional options for specifying whether the view is persistent (i.e., pre-computed and stored in the database) or transient (i.e., computed when a request for the view is received). In other implementations, the views 172 may be stored separately from the database as scripts or other programs operable to query the database 168 and present the data required by the view.

As illustrated, database 168 also includes stored procedures 174. Generally, a stored procedure is a sub-routine that is accessible to clients and programs that access a relational database. For example, a database might include a stored procedure called “max( )” that determines the maximum value in a returned series of integers, or a procedure called “sum( )” that produces a total when given a series of integers. Stored procedures might also be used to process data already stored in the database, or to process data as it is being inserted into the database. In some cases, the stored procedures 174 may be used to process the event data received from event sources 190 and 192 in order to produce one or more data layers representing the various views provided by the process intelligence server 133. In other cases, the stored procedures 174 may be used to generate any transient views provided in response to requests from clients by the process intelligence server 133.

Database 168 may also include service artifacts 176. In some implementations, the service artifacts 176 may include intermediate data formats used in processing the event data to produce the various layers. The data staging component 152 and the data view component 154 may produce various service artifacts as part of their processing. In some implementations, these service artifacts may include temporary or permanent database tables, views, files, or other data.

In illustrated FIG. 1, database 168 may include Web Applications 178. In some implementations, Web Applications 178 may include web applications for exposing data stored in the database 168 to external users and/or systems. The Web Applications 178 may be implemented in any appropriate technology such as, for example, HTML5, Javascript®, PHP, or any other technology or combination of technologies. In some instances, the Web Applications 178 are applications relating to access in-memory and other types of databases.

Illustrated database 168 may also include observation projects metadata 180. As discussed previously, observation projects metadata 180 may be used by the process intelligence engine 150 in staging and processing the event data received from the event sources, as well as providing views of the data at various levels. In some implementations, the observation projects metadata 180 is produced by the process visibility component 156 as a result of a user or external system specifying attributes of a business scenario to be observed.

Database 168 may also include event data 182. As discussed previously, event data 182 may be received, retrieved, identified, replicated, or otherwise obtained from the one or more event sources 190 and 192. In some instances, the event data 182 is stored in an unmodified format as it is received from event sources 190 and 192. This unmodified format may be referred to as “raw event data.” In some implementations, this raw event data is the basis for the staging, processing, correlation, and, ultimately, data view processing performed by the process intelligence engine 150. In other implementations, the system performs initial normalization or harmonization steps prior to inserting the event data 182 into the database 168, so the event data 182 is not truly “raw.” Such processing may include translation, filtering, derivation or any other suitable processing.

In some instances, the event data 182 can be used as the base for deriving additional data layers 184. In such cases, the event data 182 is processed to produce one or more data layers containing data useful for analyzing the respective business scenarios identified to the system. In some cases, the data layers 184 may include references to the original event data 182 from which they were derived. For example, the event data 182 may include an event representing the start of a particular process instance. In such a case, the event may include a unique identifier, such as an event ID. A data layer 184 that is produced by processing the event data 182 may include an event corresponding to the original event from the event data 182. The new event may include additional derived or external information about the event, such as, for example, an identifier representing the business scenario associated with the event. In such cases, the new event in the data layer 184 may include the event ID of the original event. In this way, the data layer 184 may allow a user or external system to “drill down” to a lower layer in order to obtain a different view of a business process. Further, different layers in the one or more data layers may also build off one another in this same manner, such that a layer may contain a reference to the associated data at the layer from which it was derived. In some cases, including these references between the layers makes it possible for the system to transition between the different layers, allowing a user or analyst to view data representing the operation of the business scenario in many different ways from a single system.

Illustrated database 168 may also include business scenarios 186. In some cases, business scenarios 186 may define groups of business process instances that interact as part of a given business process. The business process instances may be executed on different business process systems, on the same business process system, or on a combination of the two. In some instances, the business scenarios 186 may also define particular events from different business process instances that are important or relevant for analysis. In other instances, the business scenarios 186 may be defined by a user who manually identifies the different business process instances and/or events involved in a particular business scenario. In other cases, the business scenarios 186 may be defined automatically by a computer system by examining event data from the event sources 190 and 192, by executing according to rules defined by a user, or by any other appropriate mechanism or combination or mechanisms.

The illustrated environment of FIG. 1 also includes the client 103, or multiple clients 103. The client 103 may be any computing device operable to connect to or communicate with at least the process intelligence server 133 via the network 130 using a wireline or wireless connection. In general, the client 103 comprises an electronic computer device operable to receive, transmit, process, and store any appropriate data associated with the environment 100 of FIG. 1.

There may be any number of clients 103 associated with, or external to, the environment 100. For example, while the illustrated environment 100 includes one client 103, alternative implementations of the environment 100 may include multiple clients 103 communicably coupled to the process intelligence server 133 and/or the network 130, or any other number suitable to the purposes of the environment 100. Additionally, there may also be one or more additional clients 103 external to the illustrated portion of environment 100 that are capable of interacting with the environment 100 via the network 130. Further, the term “client” and “user” may be used interchangeably as appropriate without departing from the scope of this disclosure. Moreover, while the client 103 is described in terms of being used by a single user, this disclosure contemplates that many users may use one computer, or that one user may use multiple computers.

The illustrated client 103 is intended to encompass any computing device such as a desktop computer, laptop/notebook computer, wireless data port, smart phone, personal data assistant (PDA), tablet computing device, one or more processors within these devices, or any other suitable processing device. For example, the client 103 may comprise a computer that includes an input device, such as a keypad, touch screen, or other device that can accept user information, and an output device that conveys information associated with the operation of the process intelligence server 133 or the client 103 itself, including digital data, visual information, or a graphical user interface (GUI).

The example environment 100 may also include or be communicably coupled to one or more event sources 190 and 192. In some implementations, these event sources are business process platforms producing events representing various aspects of running business processes, such as, for example, state transitions, error conditions, informational messages, failure conditions, processes starting, process terminating, and other events and indications related to the running processes. The event sources 190 and 192 may provide a stream of these events to the process intelligence server 133 in the form of messages sent across network 130. In some implementations, these event messages are sent in real-time or pseudo real-time, while in other implementations the messages are cached by the event source 190 and 192 and sent in large groups. In still other implementations, the process intelligence server 133 polls the event sources 190 and 192 requesting any new events and the event sources respond with any events produced since the last poll. In another implementation, the event sources 190 and 192 communicate events by calling methods exposed through an API associated with process intelligence server 133. In still other cases, the process intelligence server 133 is integrated into the event sources 190 and 192.

In some instances, the event sources 190 and 192 may insert events directly into database 168 or may communicate events from associated databases into database 168 through the use of replication protocols.

The event sources 190 and 192 may produce business process events in different formats such as, for example, BPEL, BPMN, advanced business application programming (ABAP), or any other appropriate format or combination of formats. In some implementations, the event sources 190 and 192 will communicate the events to process intelligence server 133 in a normalized event format different from their native event formats by performing a translation prior to sending the event.

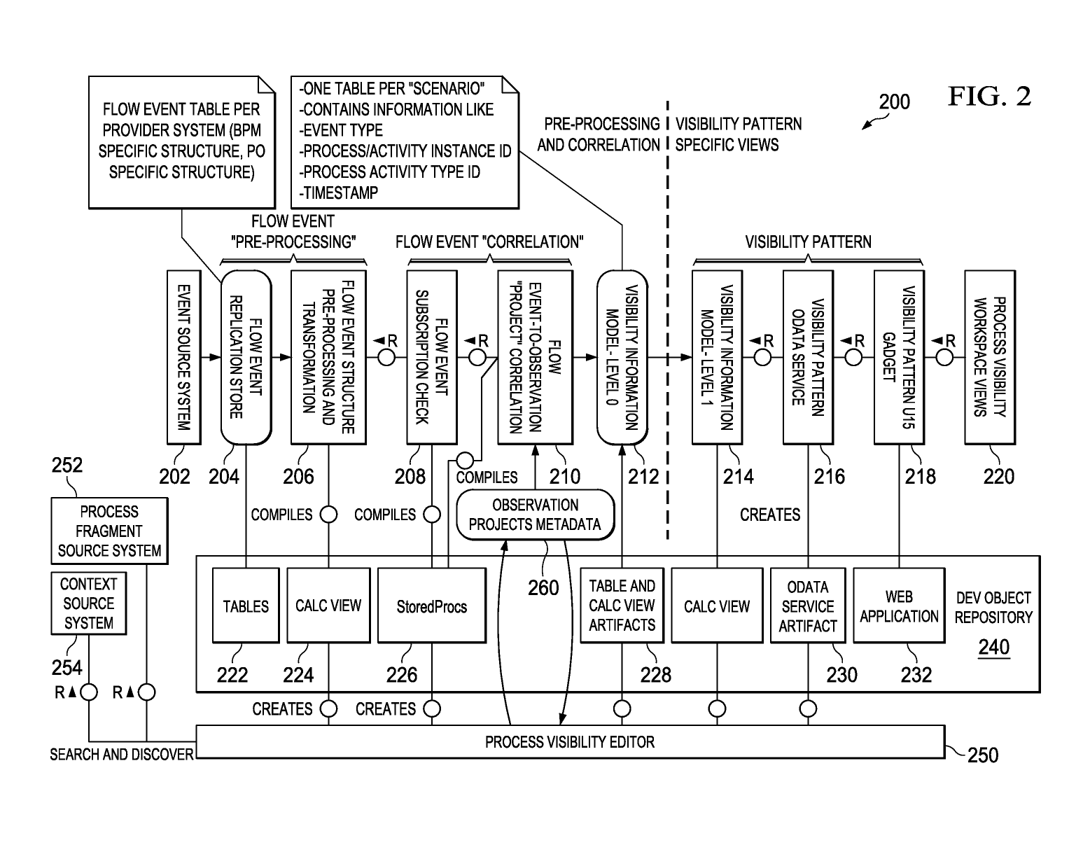

FIG. 2 is a block diagram illustrating an example system 200 for processing events received from event sources to produce the multi-layered data set. Generally, the illustrated system 200 is divided into two sections: pre-processing/correlation, and visibility. In some implementations, the example system 200 may include or be communicably coupled to a development object repository 240, and a process visibility editor 250.

The example system 200 may include or be communicably coupled to an event source system 202. In some implementations, the event source system 202 may be identical or similar to the event sources 190 and 192 discussed relative to FIG. 1, while in other implementations the event source system 202 may be different. As illustrated, the event source system 202 may be communicably coupled to a flow event replication store 204. The flow event replication store 204 may store events from the event source system 202 in a raw format, similar to event data 182 in FIG. 1. In other implementations, the flow event replication store 204 is a replicated table included in both the event source system 202 and the example system 200 that is kept synchronized by the database engines of the respective systems. The flow event replication store 204 may include one or more tables 222 which may be similar to or identical in structure to the tables 170 discussed relative to FIG. 1.

The illustrated system 200 also includes a flow event pre-processing and transformation component 206. In some cases, the flow event pre-processing and transformation component 206 may be communicably coupled to the flow event replication store 204. In some instances, the flow event pre-processing and transformation component 206 reads raw event data from the flow event replication store 204 and performs pre-processing and transformation procedures on the event data during the process of preparing one or more data layers from the raw event data. In some instances, the functionality of the flow event structure pre-processing and transformation component 206 includes or is similar to some aspect of the data staging component 152 discussed relative to FIG. 1, and may include normalizing or otherwise translating the raw event data stored in the flow event replication store 204 into a common format to be processed by other parts of the system. The flow event structure pre-processing and transformation component 206 may create one or more calc. views 224. In some implementations, these views may be identical or similar to the views 172 discussed relative to FIG. 1.

The illustrated system 200 may also include a flow event subscription check component 208 operable to determine whether a particular event is relevant or important to any particular business scenario. If an event is deemed not important, it may not be included in the subsequently produced data layer related to a particular business scenario. This filtering of events may occur according to the observation projects metadata 260 or according to any other specification of which events are important to a given business scenario.

The illustrated system 200 may also include a flow event-to-observation project correlation component 210 communicably or otherwise coupled to the flow event subscription check component 208. The flow event-to-observation project correlation component 210 may operate to correlate events from various business process instances into identified business scenarios. In some implementations, the flow event-to-observation project correlation component 210 performs this correlation in a manner similar to or identical to the data staging component 152 discussed relative to FIG. 1.

The illustrated system 200 may also include a first visibility information model 212 which may also be referred to as “Level Zero.” In some cases, Level Zero 212 is a data layer as illustrated in FIG. 1. Level Zero 212 may represent a view of business scenarios as defined by an analyst using a tool to interface with the system 200, such as the process visibility editor 250 (discussed below). In some implementations, Level Zero 212 is a persistent data layer upon which other transient upper data layers are derived. In other cases, Level Zero 212 is itself a transient layer produced on-demand in response to a received request for data. In some implementations, Level Zero 212 is stored in a database, such as database 168 of FIG. 1. In some implementations, Level Zero 212 may produce various tables and view artifacts 228 that represent various aspects of the first visibility information model 212.

The illustrated system 200 may also include a second visibility information model 214, which may also be referred to as “Level One.” In some cases, the Level 1 214 is a data layer, as illustrated in FIG. 1. In some implementations, Level One 214 may be a transient data layer produced in response to a request for a specific data view. In other implementations, Level One 214 may be a persistent data layer. In some implementations, Level Zero and Level One include references between one another to allow a user or analyst to “drill down” or “drill up” from one layer to another, as described relative to FIG. 1. Using these references, it may be possible for a user or analyst to access any data layer from any other data layer.

The illustrated system 200 also includes multiple process visibility workspace views 220. In some implementations, these views are visual representations of the data produced in the second visibility information model 214. The data may be presented to users or external systems through a graphical user interface such as a web page. In other cases, the visibility workspace views 220 may be presented to users in the form of generated reports delivered to the user such as, for example, by email. In such instances, the reports may be in a format readable by standard desktop applications. Such formats may include Excel, Postscript, PDF, Word Doc, Access database, plain text, or any other suitable format or combination of formats.

The illustrated system 200 may also include a visibility pattern Odata service 216 and a visibility pattern UI5 gadget 218. In some implementations, these components may produce and present the process visibility workspace views 220 to the user. In other implementations, these components perform additional processing on the second visibility information model 214 before presenting the information contained therein to the requesting user.

The illustrated system 200 may also include or be communicably coupled to a process visibility editor 250. In some implementations, the process visibility editor 250 is a graphical or other interface that allows a user to identify and design the different data layers in order to allow the user to better view running business scenarios. In some implementations, this is accomplished by allowing the user to identify the different business process instances that are included in each business scenario, and by allowing the user to specify what data from a business scenario is important for them to see. For example, a user may identify a first event in a first process instance to be relevant to a certain business scenario, and identify a second event in a second instance as relevant to the same business scenario. In some implementations, the process fragment source system 252 provides information to the process visibility editor 250 regarding which process instances are available and/or currently running in a given business system or set of business systems. In other implementations, the context source system 254 provides information to the process visibility editor 250 regarding which process instances are related to which business scenarios.

The illustrated system 200 may also include stored procedures 226. In some cases, stored procedures 226 are similar or identical to the stored procedures 174 described relative to FIG. 1, while in other cases the stored procedures 226 may be configured appropriately for the illustrated system 200. The illustrated system 200 may also include Odata service artifacts 230. In some cases, the Odata service artifacts 230 are similar or identical to the service artifacts 176 described in FIG. 1, while in other cases the Odata service artifacts 230 may be configured appropriately for the illustrated system 200. The illustrated system 200 may also include Web Applications 232. In some cases, the Web Applications 232 are similar or identical to the Web Applications 178 described in FIG. 1, while in other cases the Web Applications 232 may be configured appropriately for the illustrated system 200.

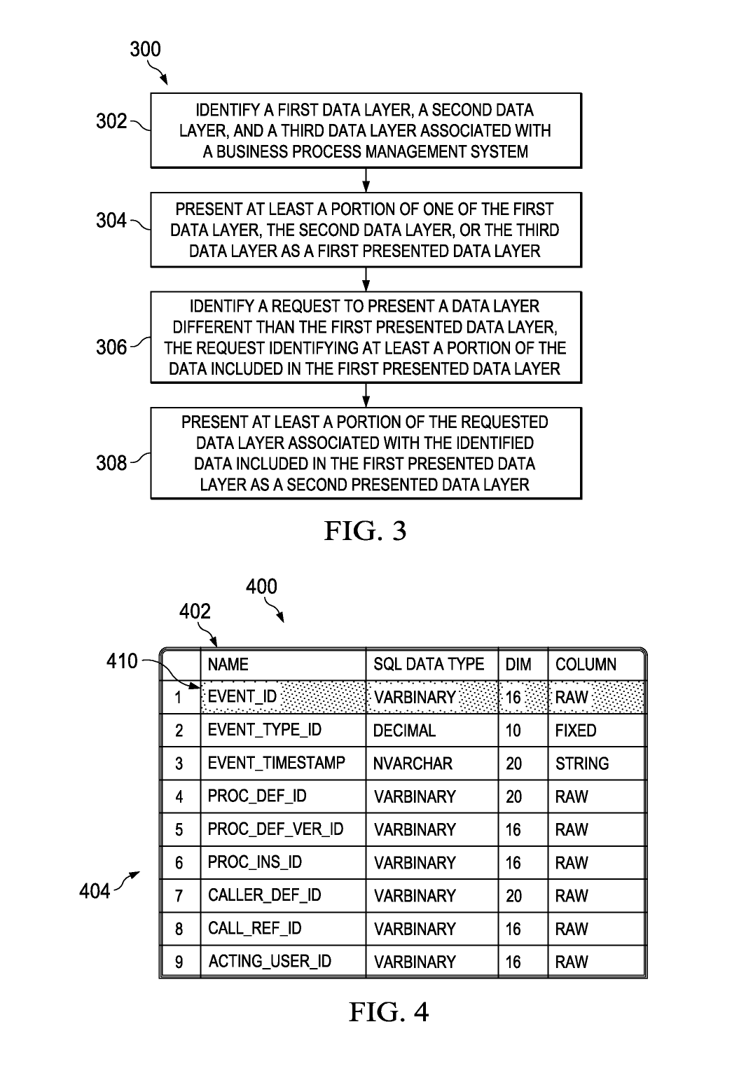

FIG. 3 is a flowchart of an example method 300 for providing process intelligence by allowing analysis of running business processes at multiple levels of detail. For clarity of presentation, the description that follows generally describes method 300 in the context of FIG. 1. However, it will be understood that method 300 may be performed, for example, by any other suitable system, environment, software, and hardware, or a combination of systems, environments, software, and hardware, as appropriate. For example, one or more of the process intelligence server, the client, or other computing device (not illustrated) can be used to execute method 300 and obtain any data from the memory of the client, the process intelligence server, or the other computing device (not illustrated).

At 302, a first data layer, a second data layer, and a third data layer associated with a business process management system are identified. As previously discussed relative to FIG. 1, the process of identifying the different data layers may include filtering, translating, correlating, and performing other processing on events at the various data layers. In some implementations, the first identified data layer may include the events received from the various event sources, and may be referred to as the “raw layer.” The second identified data layer, in some cases, may be derived from this first data layer, and may be created by normalizing the first data layer, correlating various events in the first data layer to each other based on an identified business scenario, and filtering out events not deemed to be important to the identified business scenario. Other implementations may include additional processing actions to derive the second data layer from the first data layer. In some cases, the third identified data layer is derived from the second data layer and is a transient layer generated when a request for data at that layer is received. In other cases, the third identified data layer is a persistent data layer that is stored in a database or other data store.

In some implementations, the first, second and third identified data layers include references between each such that the third identified data layer includes one or more reference to the second identified data layer, and the second identified data layer includes one or more references to the first identified data layer. Generally, in such implementations, a data layer includes one or more references to the data layer from which it was derived. In other implementations, a data layer may include one or more references to other layers from which it was not derived. The references between the layers may include referential constraints such as foreign keys in implementations utilizing database technologies. In other instances, the data layers may simply include portions of data identical to other layers as the references.

At 304, at least a portion of one of the first data layer, the second data layer, or the third data layer are presented as a first presented data layer. In some implementations, presenting the presented data layer may include presenting a report to the user including the presented data layer. The report may be a visual report such as a chart or a table, or may simply be a raw copy of the data included in the presented data layer. In other cases, the visibility workspace views may be presented to users in the form of generated reports delivered to the user such as, for example, by email. In such instances, the reports may be in a format readable by standard desktop applications. Such formats may include Excel, Postscript, PDF, Word Doc, Access database, plain text, or any other suitable format or combination of formats.

At 306, a request to present a data layer different than the first presented data layer is identified, the request identifying at least a portion of the data included in the first presented data layer. The request to present a different data layer may originate from a user selecting a visual component on a graphical user interface to indicate the desire to see a different view than the current view. For example, a user viewing an analytical view of the business process system might wish to switch to a lower level observational or raw view of the data related to the business process system or to a particular business scenario related to the business process system. In another implementation, an automated system might wish to programmatically investigate data at a different layer from the layer it originally queried. The system may communicate this by sending an indication to the process intelligence system such as, for example, through an API or other messaging protocol.

At 308, at least a portion of the requested data layer associated with the identified data included in the first presented data layer is presented as a second presented data layer. In some implementations, the requested data layer is identified by traversing references in the presented data layer to get to the requested data layer. For example, in the case where the third data layer is presented first and the first data layer is requested at 306, the method may traverse the reference from the third data layer to the second data layer, and then the reference from the second data layer to the first data layer. In the case where contiguous data layers are selected, the method may traverse only a single reference, such as from the third to the first. In implementations including references between non-contiguous layers, the method may utilize the references to navigate directly between the layers, such as from the first layer to the third layer.

Although the method 300 and the previous disclosure provides examples including two and sometimes three distinct layers, these implementations are presented for exemplary purposes only and are not meant to be limiting. The present disclosure contemplates implementations including greater or fewer numbers of layers, and also implementations including only a single data layer.

FIG. 4 illustrates an example data format 400 for an example first data layer of an example multi-layer data set. The table presented shows the structure of a database table that may hold the example first data layer. This presentation is for exemplary purposes only, and is not meant to limit the current disclosure to implementations including a database.

As indicated by the column headers 402, the table shows each column name in the database table, its type, and its size. The column names 404 in the name column represent columns in the first layer database table. These columns may hold different attributes of an event produced by an event source, such as the event ID (EVENT_ID), the event type (EVENT_TYPE_ID), a timestamp marking when the event was generated or received (EVENT_TIMESTAMP), and various other information about the received event. Event ID 410 is a unique identifier representing the event and the primary key of the example first layer database table. Event ID 410 will be used to tie the second data layer, discussed in the next figure, to the particular row in the first layer database table.

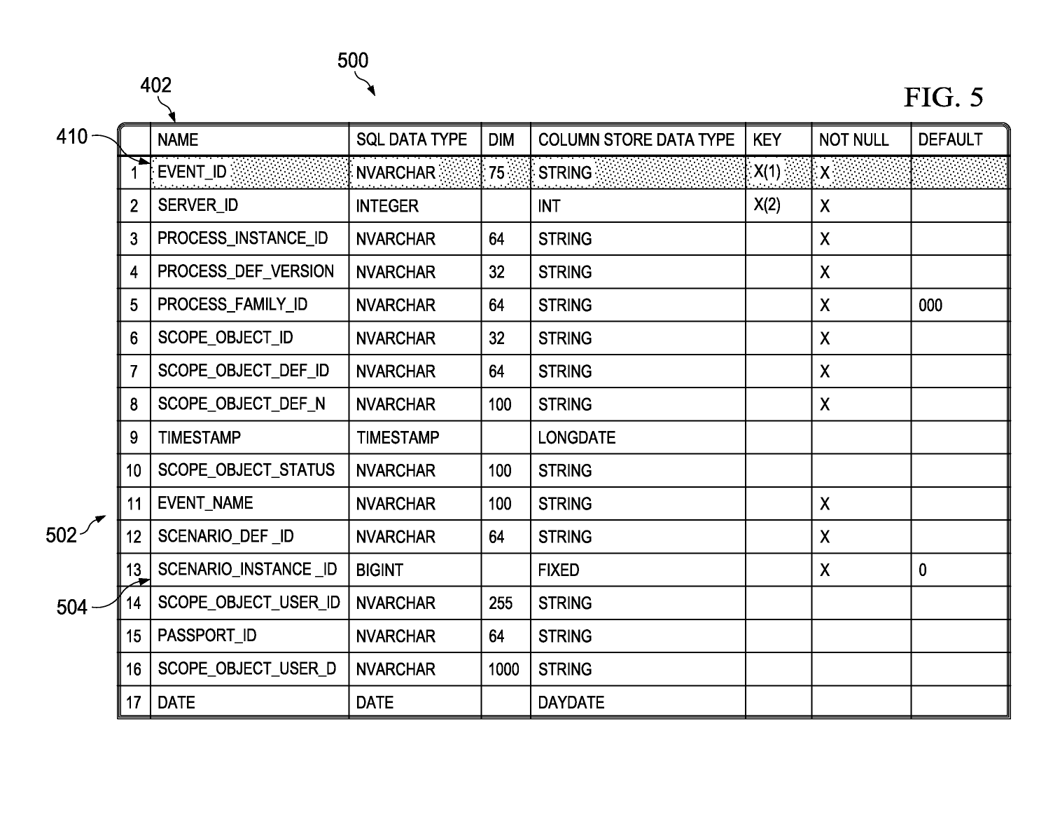

FIG. 5 illustrates an example data format 500 for an example second data layer of the example multi-layer data set. Again, as in FIG. 4, the table presented shows the structure of a database table that may hold the example first data layer. This presentation is for exemplary purposes only, and is not meant to limit the current disclosure to implementations including a database.

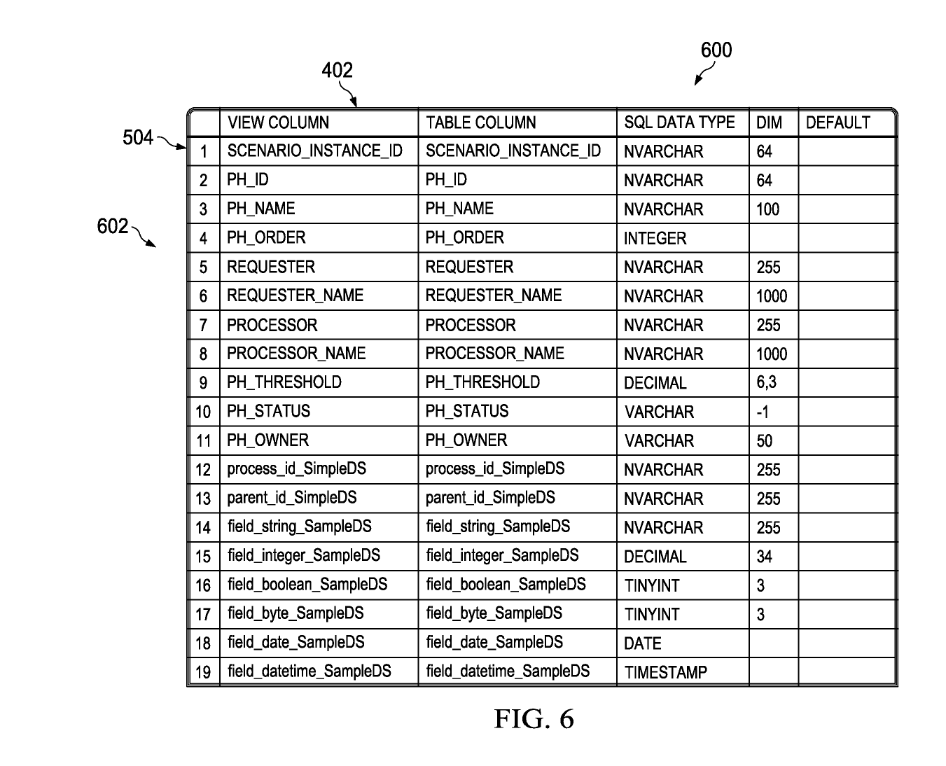

Column headers 402 again show each column name in the database table, its type, and its size. The column names 502 in the name column represent columns in the second layer database table. As discussed previously, the event ID 410 from the first layer data table is included in the second layer data table. This allows programs to retrieve data from the first data layer provided they have already retrieved data from the second data layer. This allows programs to switch back and forth between viewing the different layers without having to query an external system or perform costly additional processing. The example data format 500 also includes a scenario instance ID 504, which will be used to tie the third data layer presented in FIG. 6 to the second data layer.

FIG. 6 illustrates an example data format 600 for an example third data layer of the example multi-layer data set. Again, as in FIG. 5, the table presented shows the structure of a database table that may hold the example first data layer. This presentation is for exemplary purposes only, and is not meant to limit the current disclosure to implementations including a database.

Column headers 402 again show each column name in the database table, its type, and its size. The column names 602 in the name column represent columns in the third layer database table. As discussed previously, the scenario instance ID 504 from the second layer data table is included in the third layer data table. This allows programs to retrieve data from the first data layer provided they have already retrieved data from the second data layer. This allows programs to switch back and forth between viewing the different layers without having to query an external system or perform costly additional processing.

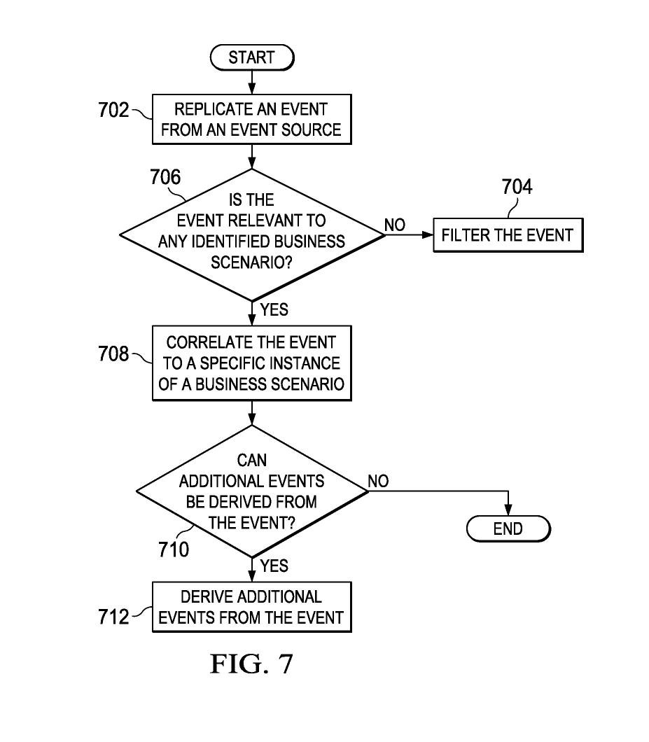

FIG. 7 is a flowchart of an example method 700 for processing business process event data received from various event sources. For clarity of presentation, the description that follows generally describes method 700 in the context of FIG. 1. However, it will be understood that method 700 may be performed, for example, by any other suitable system, environment, software, and hardware, or a combination of systems, environments, software, and hardware, as appropriate. For example, one or more of the process intelligence server, the client, or other computing device (not illustrated) can be used to execute method 700 and obtain any data from the memory of the client, the process intelligence server, or the other computing device (not illustrated).

At 702, an event is replicated from an event source. In some implementations, the event may be replicated by a database engine according to standard replication techniques. In other implementations, the event may be sent from a remote event source via a network or may be requested from the remote event source by the method 700. Further, any other technique described relative to FIG. 1 or 2, or any other appropriate technique or combination of techniques for acquiring an event from an event source, may be used.

At 704, a determination is made whether the event is relevant to any identified business scenario. In some cases, relevance may be determined according to a list of relevant events for a particular business scenario created by a user or automatically by an external system. In other cases, relevance may be determined according to general rules regarding what events are important. These rules may include relevant event types, event sources, or other attributes identified an event as relevant. If the event is determined not to be relevant to any identified business scenario, the method 700 continues to 706, where the event is filtered. In some implementations, filtering includes not storing the event as part of the new data layer. In other implementations, filtering also includes deleting the filtered event from the original stored event data. In still other implementations, the event is still stored at the new data layer but is marked with a filtered status. In still other cases, filtering may include modifying the event and/or creating a new event including some of the information from the filtered event. In such cases, although the event has been determined not to be relevant, it may be used to derive other important events. In some cases, filtering includes storing the event in a temporary storage and waiting for additional events related to it to be received before taking an action, such as deriving a new event. In cases where the event is further processed as part of the filtering, the method 700 may continue to 708, while in other cases the method 700 may end.

If the event is determined to be relevant, the method 700 continues to 708, where the event is correlated to a specific instance of a business scenario. This may involve correlating events from different systems or from different business process instances to produce a unified view of the activity of a business scenario instance. In some implementations, this correlation occurs as discussed relative to FIGS. 1 and 2 of the present disclosure, while in other implementations other appropriate techniques are used.

At 710, a determination is made whether additional events can be derived from the event. This determination may be made by examining predetermined rules governing what events can be derived, and how to do so. These rules may be specified by a user, deduced by a system through machine learning or another technique, or may be created by any other suitable technique. If additional events can be derived from the event, the method 700 continues to 712.

At 712, additional events are derived from the event. For example, the method 700 may derive from the receipt of a “stop” event for a certain process instance that a subsequent process instance responsible for the next task in a business scenario has started, and may thereby create a “start” event for that process instance. In other cases, one or more events may be derived from a single event or from a series of one or more events.

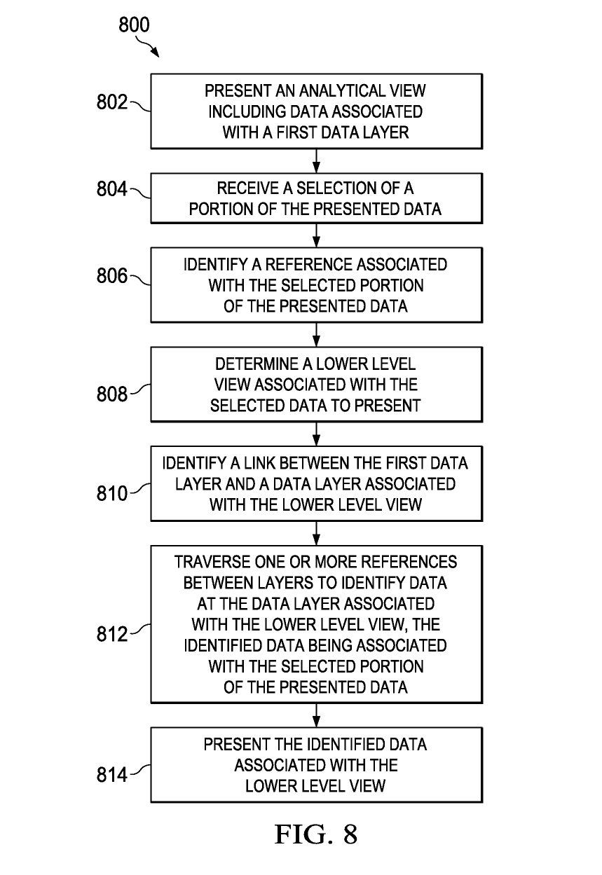

FIG. 8 is a flowchart of an example method 800 for transitioning from a high level view of business process data to a lower level view. In this description, the transition is from an analytical view to either an observation or a tactical view. For clarity of presentation, the description that follows generally describes method 800 in the context of FIG. 1. However, it will be understood that method 800 may be performed, for example, by any other suitable system, environment, software, and hardware, or a combination of systems, environments, software, and hardware, as appropriate. For example, one or more of the process intelligence server, the client, or other computing device (not illustrated) can be used to execute method 800 and obtain any data from the memory of the client, the process intelligence server, or the other computing device (not illustrated).

At 802, an analytical view is presented including data associated with a first data layer. In some implementations, this analytical view corresponds to the second visibility information model 214 of FIG. 2, and is a transient data layer generated on-demand in response to a request. In other implementations, the analytical view may be a lower data layer at any level in the data hierarchy.

At 804, a selection of a portion of the presented data is received. In some cases, this selection of data may be performed by a user interacting with a graphical user interface. In other cases, the selection may be performed by an external system or a hardware or software application operating without user input.

At 806, a reference associated with the selected portion of the presented data is identified. In some implementations, this reference is similar or identical to the references between data layers illustrated in FIGS. 4, 5 and 6. In other implementations, the references are stored in an external data store such as a schema, a data map, or any other appropriate mechanism for specifying references between different pieces of data.

At 808, a lower level view associated with the selected data to present is determined. In some implementations, this determination occurs automatically. In other cases, the determination is made by a user selecting a lower level view from a graphical user interface.

At 810, a link between the first data layer and a data layer associated with the lower level view is identified. In some cases, this may involve identifying a direct reference between the first data layer and the data layer associated with the lower level view. In other cases, identifying the link may involve an indirect reference, such that the method must follow multiple references to transition between non-contiguous layers. For example, the method may identify a reference from a third layer to a second layer, and then from the second layer to a first layer, in order to transition from the third layer to the first layer.

At 812, one or more references between layers are traversed to identify data at the data layer associated with the lower level view, the identified data being associated with the selected portion of the presented data. Traversing the different layers may involve querying a database table associated with the data layer associated with the lower level view. In such a case, the reference included in the presented data may be used to query the table. As discussed above, this traversal may span multiple layers, with the process of querying using the reference data occurring once per layer. In implementations not including a database, this traversal may occur in any appropriate manner such as following pointers in an application's memory, following inodes in a file system, following URLs in a distributed system, or any other mechanism or combination of mechanisms.

At 814, the identified data associated with the lower level view is presented. As discussed previously, this presentation may include any visual or raw data presentation of the identified data. In some cases, the identified data is presented by refreshing a graphical user interface to show the identified data. In other cases, the identified data is shown alongside the originally presented, higher level data.

Although the illustrated example discusses selecting a lower level view and transition from a higher level view, the present disclosure also contemplates transitioning from a low level view to a higher level view of the selected data. The mechanisms described herein for using the references between data layers to transition between the layers would also be operable to allow transition from a low level layer to a higher level layer.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method executed by one or more processors, the method comprising:
identifying a first data layer, a second data layer, and a third data layer associated with a business process management system, the third data layer derived from the second data layer and including at least one reference to the second data layer and the second data layer derived from the first data layer and including at least one reference to the first data layer;
presenting at least a portion of one of the first data layer, the second data layer, or the third data layer as a first presented data layer;
identifying a request to present a data layer different than the first presented data layer, the request identifying at least a portion of the data included in the first presented data layer; and
presenting at least a portion of the requested data layer associated with the identified data included in the first presented data layer as a second presented data layer.

2. The computer-implemented method of claim 1, wherein presenting the second presented data layer includes utilizing at least one of the references between the first presented data layer and the second presented data layer to transition from the first presented data layer to the second presented data layer.

3. The computer-implemented method of claim 1, wherein:
the first data layer includes event data in two or more different formats from two or more heterogeneous data sources; and
the second data layer includes event data from the first data layer normalized in a common format.

4. The computer-implemented method of claim 3, wherein identifying the second data layer includes correlating events from different sources of the two or more heterogeneous data sources, the correlated events relating a common business scenario.

5. The computer-implemented method of claim 1, wherein identifying the second data layer includes:
determining if an event from the first data layer is relevant to a business scenario;
including the event in the second data layer upon determining that the event is relevant to the business scenario; and
filtering the event from the second data layer upon determining that the event is irrelevant to the business scenario.

6. The computer-implemented method of claim 1, wherein identifying the second data layer includes deriving a second event from a presence of a first event in the first data layer.

7. The computer-implemented method of claim 1, wherein the third data layer is a transient data layer produced in response to the identified request, and the first and second data layers are persistent data layers stored in a database.

8. The computer-implemented method of claim 1, wherein the first, second and third data layers are identified according to a user-specified configuration.

9. The computer-implemented method of claim 1, wherein each of the first, second and third data layers include a reference to each of the other different data layers.

10. A computer program product encoded on a tangible, non-transitory storage medium, the product comprising computer readable instructions for causing one or more processors to perform operations comprising:
identifying a first data layer, a second data layer, and a third data layer associated with a business process management system, the third data layer derived from the second data layer and including at least one reference to the second data layer and the second data layer derived from the first data layer and including at least one reference to the first data layer;
presenting at least a portion of one of the first data layer, the second data layer, or the third data layer as a first presented data layer;
identifying a request to present a data layer different than the first presented data layer, the request identifying at least a portion of the data included in the first presented data layer; and
presenting at least a portion of the requested data layer associated with the identified data included in the first presented data layer as a second presented data layer.

11. The computer program product of claim 10, wherein presenting the second presented data layer includes utilizing at least one of the references between the first presented data layer and the second presented data layer to transition from the first presented data layer to the second presented data layer.

12. The computer program product of claim 10, wherein:
the first data layer includes event data in two or more different formats from two or more heterogeneous data sources; and
the second data layer includes event data from the first data layer normalized in a common format.

13. The computer program product of claim 12, wherein identifying the second data layer includes correlating events from different sources of the two or more heterogeneous data sources, the correlated events relating a common business scenario.

14. The computer program product of claim 10, wherein identifying the second data layer includes:
determining if an event from the first data layer is relevant to a business scenario;
including the event in the second data layer upon determining that the event is relevant to the business scenario; and
filtering the event from the second data layer upon determining that the event is irrelevant to the business scenario.

15. The computer program product of claim 10, wherein identifying the second data layer includes deriving a second event from a presence of a first event in the first data layer.

16. The computer program product of claim 10, wherein the third data layer is a transient data layer produced in response to the identified request, and the first and second data layers are persistent data layers stored in a database.

17. The computer program product of claim 10, wherein the first, second and third data layers are identified according to a user-specified configuration.

18. The computer program product of claim 10, wherein each of the first, second and third data layers include a reference to each of the other different data layers.

19. A system, comprising:
memory for storing data; and
one or more processors operable to:
identify a first data layer, a second data layer, and a third data layer associated with a business process management system, the third data layer derived from the second data layer and including at least one reference to the second data layer and the second data layer derived from the first data layer and including at least one reference to the first data layer;
present at least a portion of one of the first data layer, the second data layer, or the third data layer as a first presented data layer;
identify a request to present a data layer different than the first presented data layer, the request identifying at least a portion of the data included in the first presented data layer; and
present at least a portion of the requested data layer associated with the identified data included in the first presented data layer as a second presented data layer.

20. The system of claim 19, wherein presenting the second presented data layer includes utilizing at least one of the references between the first presented data layer and the second presented data layer to transition from the first presented data layer to the second presented data layer.
